(19) United States
(12) Patent Application Publication
(10) Pub. No.: US 2012/0007391 A1
(43) Pub. Date: Jan. 12, 2012

(54) Tackle Bucket

(76) Inventor: Jim A. McCaslin, Russellville, AR (US)

(21) Appl. No.: 13/179,661

(22) Filed: Jul. 11, 2011

Related U.S. Application Data
(60) Provisional application No. 61/362,861, filed on Jul. 9, 2010.

(51) Int. Cl. A47C 7/62; A01K 97/10; A47C 31/00

(52) U.S. Cl. 297/183.1; 297/217.1; 43/21.2

(57) ABSTRACT

A tackle bucket comprising a container, wherein said container comprises an open end and a closed end, and an inner surface and outer surface; at least one tackle box attached to said outer surface of said container; and a seat, wherein said seat is attached to said open end of said container.

### CROSS-REFERENCE TO RELATED APPLICATIONS

This application claims the benefit of U.S. Provisional Application No. 61/362,861, entitled “Tackle Bucket” and filed Jul. 9, 2010. The complete disclosure of said provisional patent application is hereby incorporated by reference.

### STATEMENT REGARDING FEDERALLY SPONSORED RESEARCH OR DEVELOPMENT

Not applicable

### BACKGROUND OF THE INVENTION

The present invention relates to fishing buckets, and in particular to a fishing bucket with a seat and attachable storage compartments.

A bucket with a seat is well known in the prior art. As one example, U.S. Pat. No. 4,436,340 to Hernandez teaches a seat mounted to the top of a fishing pail. The seat alleviates the need for the fisherman to carry a chair separately. However, prior art fishing buckets still require the fisherman to carry his tackle box and other fishing supplies separately which requires additional time and effort on the part of the fisherman.

The prior art also teaches a combined tackle box and seat. See, e.g., U.S. Pat. No. 2,264,744 to Dunnam; U.S. Pat. No. 3,206,266 to Holloway et al. However, these prior art tackle boxes with a seat do not provide a bucket for holding caught fish.

U.S. Pat. No. 5,319,877 to Hagan and U.S. Pat. No. 5,755,057 to Dancer teach a tackle bucket capable of receiving multiple tackle trays in the interior of the bucket. The tackle buckets also provide for a seat on top of the tackle bucket. The drawback to these tackle buckets is the limited space for caught fish because the tackle trays are contained inside the tackle bucket.

These limitations of the prior art are overcome by the present invention as described below.

### BRIEF SUMMARY OF THE INVENTION

The present invention is directed to an apparatus comprising (a) a container, wherein said container comprises an open end and a closed end, and an inner and outer surface; (b) at least one tackle box attached to said outer surface of said container; and (c) a seat, wherein said seat is attached to said open end of said container.

These and other features, objects and advantages of the present invention will become better understood from a consideration of the following detailed description of the preferred embodiments in conjunction with the drawings as described.

### BRIEF DESCRIPTION OF THE DRAWINGS

FIG. 1 is a top perspective view of the preferred embodiment of the present invention.

FIG. 2 is a first side view of the preferred embodiments of the present invention.

FIG. 3 is a top view of the preferred embodiment of the present invention.

FIG. 4 is a second side view of the preferred embodiment of the present invention.

### DETAILED DESCRIPTION OF THE INVENTION

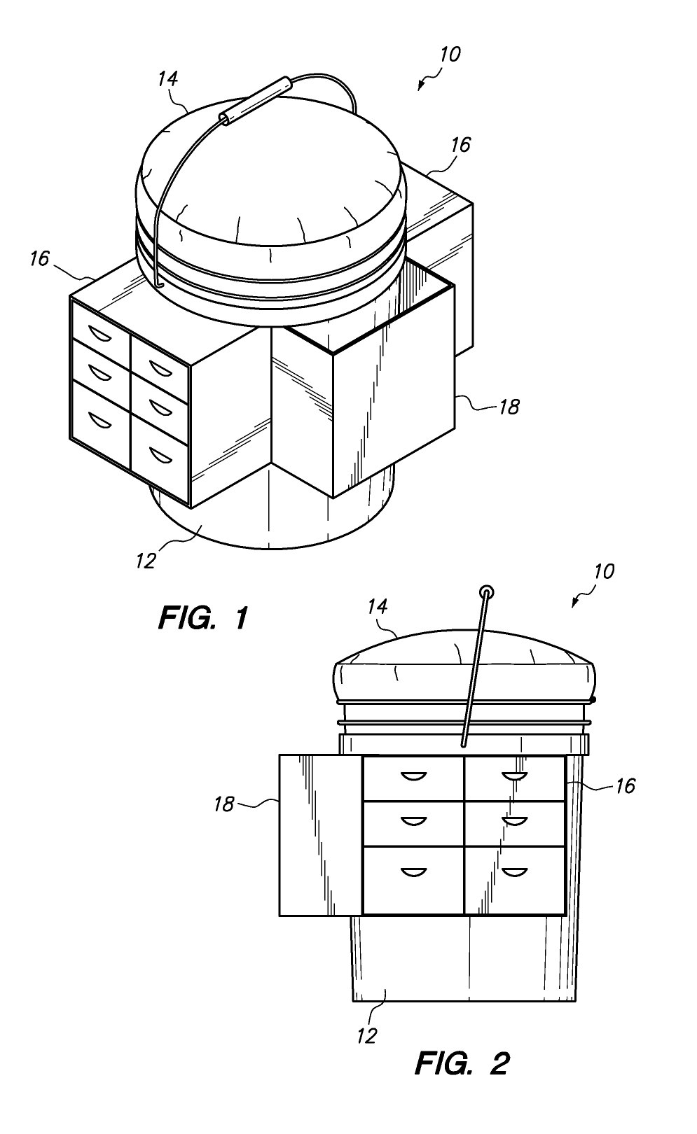

With reference to FIGS. 1-4, the preferred embodiment of the present invention may be described. The tackle bucket 10 is comprised of a container 12, a seat 14, at least one tackle box 16, and a storage bin 18. The container 12 is preferably a standard five gallon bucket. The container 12 preferably is 14.5 inches in height, has an open top diameter of 11.75 inches and a closed bottom diameter of 10.5 inches. The tackle bucket 10 also preferably comprises a handle to allow the bucket to be easily carried.

The seat 14 is hinge mounted to the back of the lip of the container 12. As such, the seat 14 can be lifted to access the contents of the container 12 while remaining attached to the container 12. The seat 14 is preferably made of two plastic discs, foam rubber, and a vinyl cover. Alternatively, the seat 14 is made completely of plastic or other components which are well known to those skilled in the art.

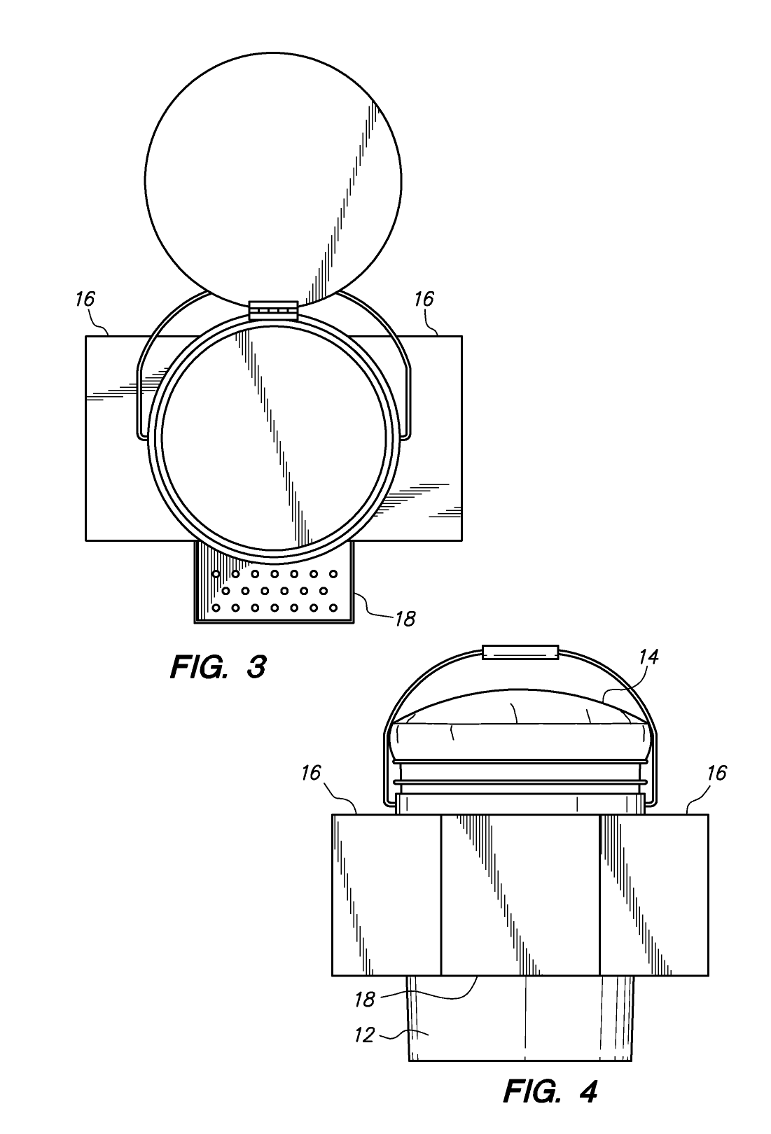

The tackle bucket 10 preferably comprises two tackle boxes 16 which are integrally mounted to the container 12 on opposite sides. The tackle boxes 16 are preferably 8-10 inches in height and 10 inches in length. Because the tackle boxes 16 are attached flush to the rounded surface of the bucket 10 as shown in FIG. 3, the tackle boxes are preferably 5-8 inches in width at their edges and 2.5-6 inches at their middle. The means for mounting the tackle boxes 16 are well known to those skilled in the art, including, but not limited to, gluing or bolting to the container 12. Each tackle box 16 has six to twelve trays for storing fishing supplies. The tackle box 16 is preferably made of plastic. Each tray is capable of being pulled out to allow the fisherman to access the contents of each tray. However, the tackle box 16 is constructed as to prevent the trays from sliding out of the closed position without being first manipulated by the fisherman.

The tackle bucket 10 also comprises a bin 18. The bin is preferably a rectangular box mounted flush to the back surface of the container 12. The bin is preferably 8-10 inches in height, 8-11 inches in length, and 3-5 inches in width at its edges. The means for mounting the bin 18 are well known to those skilled in the art including, but not limited to, gluing or bolting to the container 12. The bin has no lid which allows easy access to the fisherman. The bin is capable of storing fishing supplies, including, but not limited to, those supplies too large to be stored in the tackle box. The bin preferably has small holes in its bottom surface to allow water to drain out as shown in FIG. 3.

In an alternative embodiment, the tackle bucket 10 comprises a seat back (not shown) and a rod holder (not shown). The seat back and rod holder may be easily attached or detached from the container 12. Because the fisherman may be fishing for a number of hours, the seat back and rod holder allow for a more comfortable fishing experience without additional strain on the back, neck, and arms.

The present invention has been described with certain preferred and alternative embodiments that are intended to be exemplary only and not limiting to the full scope of the invention.

We claim:

1. An apparatus comprising:
a. a container, wherein said container comprises an open end and a closed end, and an inner surface and outer surface;
b. at least one tackle box attached to said outer surface of said container; and
c. a seat, wherein said seat is attached to said open end of said container.

2. The apparatus of claim 1, wherein said seat is attached to said open end of said container via a hinge.

3. The apparatus of claim 1, wherein said container is a bucket.

4. The apparatus of claim 1, wherein said at least one tackle box attaches flush to said outer surface of said container.

5. The apparatus of claim 1, wherein said tackle box comprises at least one slidable tray.

6. The apparatus of claim 1 further comprising a bin having an open end and a closed end, said bin attached to said outer surface of said container.

7. The apparatus of claim 6 wherein said bin further comprises drainage holes in said closed end.

8. The apparatus of claim 6 wherein said bin attaches flush to said outer surface of said container.

9. The apparatus of claim 1 wherein said seat has a back.

10. The apparatus of claim 1 further comprising a rod holder attached to said container.

11. The apparatus of claim 1 comprising two tackle boxes.

12. The apparatus of claim 11 wherein said two tackle boxes are attached on opposite sides of said outer surface of said container.

13. The apparatus of claim 1 further comprising a handle attached to said container.
